(19) United States
(12) Patent Application Publication
(10) Pub. No.: US 2025/0057230 A1
(43) Pub. Date: Feb. 20, 2025

(54) PROVISION SYSTEM

(71) Applicant: Nicoventures Trading Limited, London (GB)

(72) Inventor: Howard ROTHWELL, London (GB)

(21) Appl. No.: 18/722,845

(22) PCT Filed: Dec. 9, 2022
(86) PCT No.: PCT/GB2022/053160

§ 371 Date: Jun. 21, 2024

(30) Foreign Application Priority Data
Dec. 22, 2021 (GB) 2118836.2

(51) Int. Cl. A24F 40/46; A24F 40/42; A24F 40/50; H05B 3/42; H05B 6/10

(52) U.S. Cl. CPC A24F 40/46; A24F 40/42; A24F 40/50; H05B 3/42; H05B 6/108

(57) ABSTRACT

An article for use in a non-combustible aerosol provision system, the article including a housing; and a substantially planar aerosol generating component having at least one elongate slot, the aerosol generating component being at least partially housed within the housing, the housing defining a capillary gap through which aerosolizable material can be fed to the aerosol generating component, wherein the capillary gap and one, more, or each elongate slot do not overlap.

### RELATED APPLICATIONS

The present application is a National Phase entry of PCT Application No. PCT/GB2022/053160 filed Dec. 9, 2022, which claims priority to GB Application No. 2118836.2 filed Dec. 22, 2021, each of which is hereby incorporated by reference in their entirety.

### FIELD

The present invention relates to a provision system, in particular to a non-combustible aerosol provision system and to components of said aerosol provision system.

### BACKGROUND

Non-combustible aerosol provision systems which generate an aerosol for inhalation by a user are known in the art. Such systems typically comprise an aerosol generating component which is capable of converting an aerosolizable material into an aerosol. In some instances, the aerosol generated is a condensation aerosol whereby an aerosolizable material is first vaporized and then allowed to condense into an aerosol. In other instances, the aerosol generated is an aerosol which results from the atomization of the aerosolizable material. Such atomization may be brought about mechanically, e.g. by subjecting the aerosolizable material to vibrations so as to form small particles of material that are entrained in airflow. Alternatively, such atomization may be brought about electrostatically, or in other ways, such as by using pressure etc.

Since such aerosol provision systems are intended to generate an aerosol which is to be inhaled by a user, consideration should be given to the characteristics of the aerosol produced. These characteristics can include the size of the particles of the aerosol, the total amount of the aerosol produced, etc.

Where the aerosol provision system is used to simulate a smoking experience, e.g. as an e-cigarette or similar product, control of these various characteristics is especially important since the user may expect a specific sensorial experience to result from the use of the system.

It would be desirable to provide aerosol delivery systems which have improved control of these characteristics.

### SUMMARY

According to a first aspect of the present disclosure, there is provided an aerosol generating component comprising: at least one elongate slit, wherein the width of one, more, or each elongate slit is up to 0.3 mm.

The width of one, more, or each elongate slit is greater than 0 mm. In some examples, the width of one, more, or each elongate slit is up to 0.25 mm. In some examples, the width of one, more, or each elongate slit is at least 0.05 mm, or at least 0.1 mm, or at least 0.15 mm. In some examples, the width of one, more, or each elongate slit is between 0.05 mm and about 0.3 mm, or between 0.05 mm and 0.3 mm, or between 0.1 mm and 0.3 mm, or between 0.15 mm and 0.25mm. In some examples, the width of one, more, or each elongate slit is about 0.2 mm.

In some examples, the aerosol generating component is substantially planar.

In some examples, the aerosol generating component comprises multiple elongate slits as defined herein.

In some examples, one, more, or each elongate slit comprises multiple elongate slit sections.

In some examples, one, more, or each elongate slit section is substantially straight.

In some examples, one, more, or each elongate slit section is curved. In some examples, the curvature is in the plane of the substantially planar aerosol generating component.

In some examples, at least two of the elongate slit sections are non-parallel with respect to each other.

In some examples, at least two of the elongate slit sections are obliquely angled with respect to each other.

In some examples, one, more or each elongate slit is open at the periphery of the aerosol generating component.

In some examples, one, more or each elongate slit is enclosed by the periphery of the aerosol generating component.

In some examples, the aerosol generating component comprises: an aerosolizable material feed section configured to receive aerosolizable material; and an aerosolization section configured to aerosolize aerosolizable material.

The aerosolization section may be characterized as that section which experiences a temperature of within 50%, or within 60%, or within 70%, or within 80% or within 90% of the maximum temperature reached by the aerosol generating component.

In some examples, one, more, or each elongate slit is provided in the aerosolization section.

In some examples, one, more, or each elongate slit does not extend into the aerosolizable material feed section. In other words, the one, more, or each elongate slit may be confined to the aerosolization section.

In some examples, one, more, or each elongate slit is connected to an elongate slot.

In some examples, one, more, or each elongate slot is provided in the aerosolization section.

In some examples, one, more, or each elongate slot does not extend into the aerosolizable material feed section.

In some examples, one, more, or each elongate slit is provided in the aerosolizable material feed section.

In some examples, the width of one, more, or each elongate slot is greater than 0.3 mm, or at least 0.35 mm. In some examples, the width of one, more, or each elongate slot is up to 3 mm, or up to 2.5 mm, or up to 2 mm, or up to 1.5 mm, or up to 1 mm, or up to 0.8 mm, or up to 0.7 mm, or up to 0.6 mm, or up to 0.55 mm. In some examples, the width of one, more, or each elongate slot is greater than 0.3 mm and up to 1 mm, or greater than 0.3 mm and up to 0.8 mm, or greater than 0.3 mm and up to 0.6 mm, or greater than 0.3 mm and up to 0.55 mm. In some examples, the width of one, more, or each elongate slot is between 0.25 mm and 1 mm, or between 0.25 mm and 0.8 mm, or between 0.25 mm and 0.6 mm, or between 0.35 mm and 0.55 mm, or between 0.4 mm and 0.5 mm.

In some examples, the aerosol generating component comprises one or more electrical connectors.

In some examples, the aerosol generating component is formed of a porous material. In some examples, the aerosol generating component is formed of an electrically conductive material. In some examples, the aerosol generating component is formed of a single layer.

In some examples, the aerosol generating component is formed from a woven or weave structure, mesh structure, fabric structure, open-pored fiber structure, open-pored sintered structure, open-pored foam or open-pored deposition structure.

In one aspect of the present disclosure, there is provided an article for use as part of a non-combustible aerosol provision system, the article comprising: an aerosol generating component according to a previous aspect of the present disclosure; and one or more of an aerosol forming chamber and a reservoir for aerosolizable material.

In one aspect of the present disclosure, there is provided a non-combustible aerosol provision system comprising: an article according to a previous aspect of the present disclosure; and a device comprising one or more of a power source and a controller.

In one aspect of the present disclosure, there is provided an aerosol generating component comprising at least one curved, elongate aperture.

In some examples, the aerosol generating component comprises multiple curved, elongate apertures as defined herein.

In some examples, one, more, or each curved, elongate aperture increases in curvature from one end of the aperture to the other end of the aperture.

In some examples, one, more, or each curved, elongate aperture is curved along at least part of its length. The part of the aperture that is curved may be provided towards the periphery of the aerosol generating component. This may help to reduce the occurrence of “hot spots” in use in locations where these are not desired. The part of the aperture that is curved may be provided in the aerosolizable material feed section.

In some examples, one, more, or each curved, elongate aperture is curved along substantially its entire length.

In some examples, the aerosol generating component is substantially planar.

In some examples, the curvature of one, more, or each curved, elongate aperture is in the plane of the substantially planar aerosol generating component.

In some examples, one, more, or each curved, elongate aperture comprises a curved portion connected to a straight portion.

In some examples, one, more, or each curved, elongate aperture comprises a slot portion connected to a slit portion.

In some examples, the width of the slot portion is greater than 0.3 mm.

In some examples, the width of the slot portion is greater than 0.3 mm, or at least 0.35 mm. In some examples, the width of the slot portion is up to 3 mm, or up to 2.5 mm, or up to 2 mm, or up to 1.5 mm, or up to 1 mm, or up to 0.8 mm, or up to 0.7 mm, or up to 0.6 mm, or up to 0.55 mm. In some examples, the width of the slot portion is greater than 0.3 mm and up to 1 mm, or greater than 0.3 mm and up to 0.8 mm, or greater than 0.3 mm and up to 0.6 mm, or greater than 0.3 mm and up to 0.55 mm. In some examples, the width of the slot portion is between 0.25 mm and 1 mm, or between 0.25 mm and 0.8 mm, or between 0.25 mm and 0.6 mm, or between 0.35 mm and 0.55 mm, or between 0.4 mm and 0.5 mm.

In some examples, the width of the slit portion is up to 0.3 mm.

The width of the slit portion is greater than 0 mm. In some examples, the slit portion has a width of up to 0.25 mm. In some examples, the width of the slit portion is at least 0.05 mm, or at least 0.1 mm, or at least 0.15 mm. In some examples, the width of the slit portion is between 0.05 mm and 0.3 mm, or between 0.1 mm and 0.3 mm, or between 0.15 mm and 0.25 mm. In some examples, the width of the slit portion is about 0.2 mm.

In some examples, one, more, or each curved, elongate aperture is open at the periphery of the aerosol generating component.

In some examples, one, more, or each curved, elongate aperture is enclosed by the periphery of the aerosol generating component.

In some examples, the aerosol generating component comprises: an aerosolizable material feed section configured to receive aerosolize aerosolizable material; and an aerosolization section configured to aerosolize aerosolizable material.

In some examples, one, more, or each curved, elongate aperture comprises a slot portion connected to a slit portion, and one, more, or each slot portion is provided in the aerosolization section.

In some examples, one, more, or each curved, elongate aperture comprises a slot portion connected to a slit portion and one, more, or each slit portion is provided in the aerosolizable material feed section.

In some examples, the aerosol generating component comprises one or more electrical connectors.

In some examples, the aerosol generating component is formed of a porous material.

In some examples, the aerosol generating component is formed of an electrically conductive material.

In some examples, the aerosol generating component is formed of a single layer.

In some examples, the aerosol generating component is formed from a woven or weave structure, mesh structure, fabric structure, open-pored fiber structure, open-pored sintered structure, open-pored foam or open-pored deposition structure.

In one aspect of the present disclosure, there is provided an article comprising: an aerosol generating component according to a previous aspect; and one or more of an aerosol forming chamber and a reservoir for aerosolizable material.

In one aspect of the present disclosure, there is provided a non-combustible aerosol provision system comprising: an article according to a previous aspect; and a device comprising one or more of a power source and a controller.

In one aspect of the present disclosure, there is provided an article for use in a non-combustible aerosol provision system, the article comprising: a housing; and a substantially planar aerosol generating component having at least one elongate slot, the aerosol generating component being at least partially housed within the housing, the housing defining a capillary gap through which aerosolizable material can be fed to the aerosol generating component, wherein the capillary gap and the one, more, or each elongate slot do not overlap.

The substantially planar aerosol generating component may comprise multiple elongate slots as defined herein.

In some examples, one, more or each elongate slot is provided inboard of the capillary gap.

In some examples, one, more or each elongate slot is connected to an elongate slit so as to provide at least one elongate aperture.

In some examples, one, more, or each elongate slit and the capillary gap overlap.

In some examples, the width of one, more, or each elongate slit is greater than 0 mm. In some examples, the width of one, more, or each elongate slit is up to 0.3 mm, or up to 0.25 mm. In some examples, the width of one, more, or each elongate slit is at least 0.05 mm, or at least 0.1 mm, or at least 0.15 mm. In some examples, the width of one, more, or each elongate slit is between 0.05 mm and 0.3 mm, or between 0.1 mm and 0.3 mm, or between 0.15 mm and 0.25 mm. In some examples, the width of one, more, or each elongate slit is about 0.2 mm.

In some examples, the width of one, more, or each elongate slot is greater than 0.3 mm, or at least 0.35 mm. In some examples, the width of one, more, or each elongate slot is up to 3 mm, or up to 2.5 mm, or up to 2 mm, or up to 1.5 mm, or up to 1 mm, or up to 0.8 mm, or up to 0.7 mm, or up to 0.6 mm, or up to 0.55 mm. In some examples, the width of one, more, or each elongate slot is greater than 0.3 mm and up to 1 mm, or greater than 0.3 mm and up to 0.8 mm, or greater than 0.3 mm and up to 0.6 mm, or greater than 0.3 mm and up to 0.55 mm. In some examples, the width of one, more, or each elongate slot is between 0.25 mm and 1 mm, or between 0.25 mm and 0.8 mm, or between 0.25 mm and 0.6 mm, or between 0.35 mm and 0.55 mm, or between 0.4 mm and 0.5 mm.

In some examples, the aerosol generating component is substantially planar.

In some examples, the aerosol generating component comprises an aerosolizable material feed section configured to receive aerosolize aerosolizable material; and an aerosolization section configured to aerosolize aerosolizable material.

In some examples, one, more or each slot is provided in the aerosolization section.

In some examples, the aerosolization section and the capillary gap do not overlap.

In some examples, the aerosolization section is provided inboard of the capillary gap.

In some examples, the aerosolizable material feed section and the capillary gap overlap.

In some examples, one, more or each elongate slot is connected to an elongate slit so as to provide at least one elongate aperture, and wherein one, more, or each slit is provided in the aerosolizable material feed section.

In some examples, the housing comprises a first carrier component and a second carrier component that are spaced apart so as to define the capillary gap between the first carrier component and the second carrier component.

In some examples, the aerosol generating component comprises one or more electrical connectors.

In some examples, the aerosol generating component is formed of a porous material.

In some examples, the aerosol generating component is formed of an electrically conductive material.

In some examples, the aerosol generating component is formed of a single layer.

In some examples, the aerosol generating component is formed from a woven or weave structure, mesh structure, fabric structure, open-pored fiber structure, open-pored sintered structure, open-pored foam or open-pored deposition structure.

In some examples, the article comprises and one or more of an aerosol forming chamber and a reservoir for aerosolizable material.

In one aspect of the present disclosure, there is provided a non-combustible aerosol provision system comprising: an article according to a previous aspect of the present disclosure; and a device comprising one or more of a power source and a controller.

It is possible to configure the system such that the airflow channel(s) and/or the aerosol generating chamber(s) and/or the aerosol generating component(s) are separable. For example, the article may be provided in a modular form in which the airflow channel(s) and/or the aerosol generating chamber(s) and/or the aerosol generating component(s) are separable.

According to another aspect of the present disclosure, there is provided:
A1. An aerosol generating component comprising at least one curved, elongate aperture.
A2. An aerosol generating component of clause A1, wherein one, more, or each curved, elongate aperture increases in curvature from one end of the aperture to the other end of the aperture.
A3. An aerosol generating component of clause A1 or A2, wherein one, more, or each curved, elongate aperture is curved along at least part of its length.
A4. An aerosol generating component of any one of clauses A1-A3, wherein one, more, or each curved, elongate aperture is curved along substantially its entire length.
A5. An aerosol generating component of any one of clauses A1-A4, wherein the aerosol generating component is substantially planar.
A6. An aerosol generating component of any one of clauses A1-A5, wherein one, more, or each curved, elongate aperture comprises a curved portion connected to a straight portion.
A7. An aerosol generating component of any one of clauses A1-A6, wherein one, more, or each curved, elongate aperture comprises a slot portion connected to a slit portion.
A8. An aerosol generating component of clause A7, wherein the width of the slot portion is greater than 0.3 mm, and the width of the slit portion is up to 0.3 mm.
A9. An aerosol generating component of any one of clauses A1-A8, wherein one, more, or each curved, elongate aperture is open at the periphery of the aerosol generating component.
A10. An aerosol generating component of any one of clauses A1-A9, wherein one, more, or each curved, elongate aperture is enclosed by the periphery of the aerosol generating component.
A11. An aerosol generating component of any one of clauses A1-A10, comprising: an aerosolizable material feed section configured to receive aerosolize aerosolizable material; and an aerosolization section configured to aerosolize aerosolizable material.
A12. An aerosol generating component of clause A11, wherein one, more, or each curved, elongate aperture comprises a slot portion connected to a slit portion, and one, more, or each slot portion is provided in the aerosolization section.
A13. An aerosol generating component of clause A11 or A12, wherein one, more, or each curved, elongate aperture comprises a slot portion connected to a slit portion and one, more, or each slit portion is provided in the aerosolizable material feed section.
A14. An aerosol generating component of any one of clauses A1-A13, comprising one or more electrical connectors.
A15. An aerosol generating component of any one of clauses A1-A14, wherein the aerosol generating component is formed of a porous material.
A16. An aerosol generating component of any one of clauses A1-A15, wherein the aerosol generating component is formed of an electrically conductive material.
A17. An aerosol generating component of any one of clauses A1-A16, wherein the aerosol generating component is formed of a single layer.
A18. An aerosol generating component of any one of clauses A1-A17, wherein the aerosol generating component is formed from a woven or weave structure, mesh structure, fabric structure, open-pored fiber structure, open-pored sintered structure, open-pored foam or open-pored deposition structure.
A19. An article comprising: an aerosol generating component of any one of clauses A1-A18; and one or more of an aerosol forming chamber and a reservoir for aerosolizable material.
A20. A non-combustible aerosol provision system comprising: an article of clause A19; and a device comprising one or more of a power source and a controller.

According to another aspect of the present disclosure, there is provided:
B1. An article for use in a non-combustible aerosol provision system, the article comprising: a housing; and a substantially planar aerosol generating component having at least one elongate slot, the aerosol generating component being at least partially housed within the housing, the housing defining a capillary gap through which aerosolizable material can be fed to the aerosol generating component, wherein the capillary gap and one, more, or each elongate slot do not overlap.
B2. An article of clause B1, wherein one, more or each elongate slot is provided inboard of the capillary gap.
B3. An article of clause B1 or B2, wherein one, more, or each elongate slot is connected to an elongate slit so as to provide at least one elongate aperture.
B4. An article of any one of clauses B1-B3, wherein one, more, or each elongate slit and the capillary gap overlap.
B5. An article of any one of clauses B1-B4, wherein the aerosol generating component is substantially planar.
B6. An article of any one of clauses B1-B5, wherein the aerosol generating component comprises an aerosolizable material feed section configured to receive aerosolize aerosolizable material; and an aerosolization section configured to aerosolize aerosolizable material.
B7. An article of clause B6, wherein one, more, or each elongate slot is provided in the aerosolization section.
B8. An article of clause B6 or B7, wherein the aerosolization section and the capillary gap do not overlap.
B9. An article of any one of clauses B6-B8, wherein the aerosolization section is provided inboard of the capillary gap.
B10. An article of any one of clauses B6-B9, wherein the aerosolizable material feed section and the capillary gap overlap.
B11. An article of any one of clauses B6-B10, wherein one, more, or each elongate slot is connected to an elongate slit so as to provide at least one elongate aperture, and wherein one, more, or each slit is provided in the aerosolizable material feed section.
B12. An article of any one of clauses B1-B11, wherein the housing comprises a first carrier component and a second carrier component that are spaced apart so as to define the capillary gap.
B13. An article of any one of clauses B1-B12, wherein the aerosol generating component comprises one or more electrical connectors.
B14. An article of any one of clauses B1-B13, comprising and one or more of an aerosol forming chamber and a reservoir for aerosolizable material.
B15. An article of any one of clauses B1-B14, wherein the aerosol generating component is formed of a porous material.
B16. An article of any one of clauses B1-B15, wherein the aerosol generating component is formed of an electrically conductive material.
B17. An article of any one of clauses B1-B16, wherein the aerosol generating component is formed of a single layer.
B18. An article of any one of clauses B1-B17, wherein the aerosol generating component is formed of a woven or weave structure, mesh structure, fabric structure, open-pored fiber structure, open-pored sintered structure, open-pored foam or open-pored deposition structure.
B19. A non-combustible aerosol provision system comprising: an article of any one of clauses B1-B16; and a device comprising one or more of a power source and a controller.

It will be appreciated that features and aspects of the invention described above in relation to the first and other aspects of the invention are equally applicable to, and may be combined with, embodiments of the invention according to other aspects of the invention as appropriate, and not just in the specific combinations described above.

### BRIEF DESCRIPTION OF THE DRAWINGS

Various embodiments will now be described in detail by way of example only with reference to the accompanying drawings in which:

FIG. 1 is a schematic representation of an aerosol provision system according to the present disclosure.

FIG. 2A is a diagram of an article for use as part of an aerosol provision system according to the present disclosure.

FIG. 2B is a diagram of a part of the article of FIG. 2A.

FIG. 2C is a cross sectional view of the article of FIG. 2A.

FIG. 2D is a front view of the article of FIG. 2A.

FIG. 2E is a rear view of the article of FIG. 2A.

FIG. 3A-C are diagrams of exemplary aerosol generating components for use in the article of FIG. 2.

FIG. 4 is a diagram of an exemplary aerosol generating component for use in the article of FIG. 2.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

As described above, the present disclosure relates, but is not limited, to non-combustible aerosol provision systems and devices that generate an aerosol from an aerosol-generating material (also referred to herein as aerosolizable material) without combusting the aerosol-generating material. Examples of such systems include electronic cigarettes, tobacco heating systems, and hybrid systems (which generate aerosol using a combination of aerosol-generating materials). In some examples, the non-combustible aerosol provision system is an electronic cigarette, also known as a vaping device or electronic nicotine delivery system (END), although it is noted that the presence of nicotine in the aerosol-generating material is not a requirement of the present disclosure. In some examples, the non-combustible aerosol provision system is an aerosol-generating material heating system, also known as a heat-not-burn system. An example of such a system is a tobacco heating system. In some examples, the non-combustible aerosol provision system is a hybrid system to generate aerosol using a combination of aerosol-generating materials, one or a plurality of which may be heated. Each of the aerosol-generating materials in such a hybrid system may be, for example, in the form of a solid, liquid or gel and may or may not contain nicotine. In some examples, the hybrid system comprises a liquid or gel aerosol-generating material and a solid aerosol-generating material. The solid aerosol-generating material may comprise, for example, tobacco or a non-tobacco product.

Throughout the following description the terms “e-cigarette” and “electronic cigarette” may sometimes be used. However, it will be appreciated these terms may be used interchangeably with non-combustible aerosol (vapor) provision system or device as explained above.

In some examples, the present disclosure relates to consumables for holding aerosol-generating material, and which are configured to be used with non-combustible aerosol provision devices. These consumables may be referred to as articles throughout the present disclosure.

The non-combustible aerosol provision system typically comprises a device part (also referred to herein as a device) and a consumable/article part (also referred to herein as an article). The device part typically comprises a power source and a controller. The power source may typically be an electrical power source, e.g. a rechargeable battery.

In some examples, the non-combustible aerosol provision system may comprise an area for receiving or engaging with the consumable/article, an aerosol generator (which may or may not be within the consumable/article), an aerosol generation area (which may be within the consumable/article), a housing, a mouthpiece, a filter and/or an aerosol-modifying agent.

In some examples, the consumable/article for use with the non-combustible aerosol provision device may comprise aerosol-generating material, an aerosol-generating material storage area (also referred to herein as a reservoir for aerosolizable material), an aerosol-generating material transfer component (e.g. a wick, such as a pad), an aerosol generator (also referred to herein as an aerosol generating component), an aerosol generation area (also referred to herein as an aerosol generation chamber), a housing, a wrapper, a filter, a mouthpiece, and/or an aerosol-modifying agent.

The systems described herein typically generate an inhalable aerosol by vaporization of an aerosol generating material. The aerosol generating material may comprise one or more active constituents, one or more flavors, one or more aerosol-former materials, and/or one or more other functional materials.

Aerosol-generating material may, for example, be in the form of a solid, liquid or gel which may or may not contain an active substance and/or flavorants. In some examples, the aerosol-generating material may comprise an “amorphous solid”, which may alternatively be referred to as a “monolithic solid” (i.e. non-fibrous). In some examples, the amorphous solid may be a dried gel. The amorphous solid is a solid material that may retain some fluid, such as liquid, within it. In some examples, the aerosol-generating material may for example comprise from about 50 wt %, 60 wt % or 70 wt % of amorphous solid, to about 90 wt %, 95 wt % or 100 wt % of amorphous solid.

The term “active substance” as used herein may relate to a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

The aerosol-former material may comprise one or more constituents capable of forming an aerosol. In some examples, the aerosol-former material may comprise one or more of glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials may comprise one or more of pH regulators, coloring agents, preservatives, binders, fillers, stabilizers, and/or antioxidants.

As used herein, the term “component” is used to refer to a part, section, unit, module, assembly or similar of an electronic cigarette or similar device that incorporates several smaller parts or elements, possibly within an exterior housing or wall. An electronic cigarette may be formed or built from one or more such components, and the components may be removably or separably connectable to one another, or may be permanently joined together during manufacture to define the whole electronic cigarette. The present disclosure is applicable to (but not limited to) systems comprising two components separably connectable to one another and configured, for example, as a consumable/article component capable of holding an aerosol generating material (also referred to herein as a cartridge or cartomizer), and a device/control unit having a battery for providing electrical power to operate an element for generating vapor from the aerosol generating material.

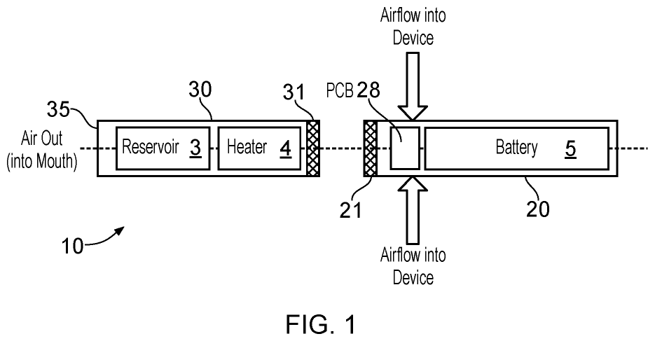

FIG. 1 is a highly schematic diagram (not to scale) of an example aerosol/vapor provision system such as an e-cigarette 10. The e-cigarette 10 has a generally cylindrical shape, extending along a longitudinal axis indicated by a dashed line, and comprises two main components, namely a control or power component or section 20 (which may be referred to herein as a device) and a cartridge assembly or section 30 (which may be referred to herein as an article, consumable, cartomizer, or cartridge) that operates as a vapor generating component.

The cartridge assembly 30 includes a storage compartment (also referred to herein as a reservoir) 3 containing an aerosolizable material comprising (for example) a liquid formulation from which an aerosol is to be generated, for example containing nicotine. As an example, the aerosolizable material may comprise around 1 to 3% nicotine and 50% glycerol, with the remainder comprising roughly propylene glycol, and possibly also comprising other components, such as water or flavorings. The storage compartment 3 has the form of a storage tank, being a container or receptacle in which aerosolizable material can be stored such that the aerosolizable material is free to move and flow (if liquid) within the confines of the tank. Alternatively, the storage compartment 3 may contain a quantity of absorbent material such as cotton wadding or glass fiber which holds the aerosolizable material within a porous structure. The storage compartment 3 may be sealed after filling during manufacture so as to be disposable after the aerosolizable material is consumed, or may have an inlet port or other opening through which new aerosolizable material can be added. The cartridge assembly 30 also comprises an electrical aerosol generating component 4 located externally of the reservoir tank 3 for generating the aerosol by vaporization of the aerosolizable material. In many examples, the aerosol generating component may be a heating element (heater) which is heated by the passage of electrical current (via resistive or inductive heating) to raise the temperature of the aerosolizable material until it evaporates. A liquid conduit arrangement such as a wick or other porous element (not shown) may be provided to deliver aerosolizable material from the storage compartment 3 to the aerosol generating component 4. The wick may have one or more parts located inside the storage compartment 3 so as to be able to absorb aerosolizable material and transfer it by wicking or capillary action to other parts of the wick that are in contact with the aerosol generating component 4. This aerosolizable material is thereby vaporized, and is to be replaced by new aerosolizable material transferred to the aerosol generating component 4 by the wick.

A heater and wick combination, or other arrangement of parts that perform the same functions, is sometimes referred to as an atomizer or atomizer assembly. Various designs are possible, in which the parts may be differently arranged compared to the highly schematic representation of FIG. 1. For example, the wick may be an entirely separate element from the aerosol generating component, or the aerosol generating component may be configured to be porous and able to perform the wicking function directly (by taking the form of a suitable electrically resistive mesh or capillary body, for example).

In some cases, the conduit for delivering liquid for vapor generation may be formed at least in part from one or more slots, tubes or channels between the storage compartment and the aerosol generating component which are narrow enough to support capillary action to draw source liquid out of the storage compartment and deliver it for vaporization. In general, an atomizer can be considered to be an aerosol generating component able to generate vapor from aerosolizable material delivered to it, and a liquid conduit (pathway) able to deliver or transport liquid from a storage compartment or similar liquid store to the aerosol generating component by a capillary force.

Typically, the aerosol generating component is at last partly located within an aerosol generating chamber that forms part of an airflow channel through the electronic cigarette/system. Vapor produced by the aerosol generating component is driven off into this chamber, and as air passes through the chamber, flowing over and around the aerosol generating element, it collects the produced vapor whereby it condenses to form the required aerosol.

Returning to FIG. 1, the cartridge assembly 30 also includes a mouthpiece 35 having an opening or air outlet through which a user may inhale the aerosol generated by the aerosol generating component 4, and delivered through the airflow channel.

The power component 20 includes a cell 5 (also referred to herein as a battery, and which may be re-chargeable) to provide power for electrical components of the e-cigarette 10, in particular the aerosol generating component 4. Additionally, there is a printed circuit board 28 and/or other electronics or circuitry for generally controlling the e-cigarette. The control electronics/circuitry connect the vapor generating element 4 to the battery 5 when vapor is required, for example in response to a signal from an air pressure sensor or air flow sensor (not shown) that detects an inhalation on the system 10 during which air enters through one or more air inlets 26 in the wall of the power component 20 to flow along the airflow channel. When the aerosol generating component 4 receives power from the battery 5, the aerosol generating component 4 vaporizes aerosolizable material delivered from the storage compartment 3 to generate the aerosol, and this is then inhaled by a user through the opening in the mouthpiece 35. The aerosol is carried to the mouthpiece 35 along the airflow channel (not shown) that connects the air inlet 26 to the air outlet when a user inhales on the mouthpiece 35. An airflow path through the electronic cigarette is hence defined, between the air inlet(s) (which may or may not be in the power component) to the atomizer and on to the air outlet at the mouthpiece. In use, the air flow direction along this airflow path is from the air inlet to the air outlet, so that the atomizer can be described as lying downstream of the air inlet and upstream of the air outlet.

In this particular example, the power section 20 and the cartridge assembly 30 are separate parts detachable from one another by separation in a direction parallel to the longitudinal axis, as indicated by the solid arrows in FIG. 1. The components 20, 30 are joined together when the device 10 is in use by cooperating engagement elements 21, 31 (for example, a screw, magnetic or bayonet fitting) which provide mechanical and electrical connectivity between the power section 20 and the cartridge assembly 30. This is merely an example arrangement, however, and the various components may be differently distributed between the power section 20 and the cartridge assembly section 30, and other components and elements may be included. The two sections may connect together end-to-end in a longitudinal configuration as in FIG. 1, or in a different configuration such as a parallel, side-by-side arrangement. The system may or may not be generally cylindrical and/or have a generally longitudinal shape. Either or both sections may be intended to be disposed of and replaced when exhausted (the reservoir is empty or the battery is flat, for example), or be intended for multiple uses enabled by actions such as refilling the reservoir, recharging the battery, or replacing the atomizer. Alternatively, the e-cigarette 10 may be a unitary device (disposable or refillable/rechargeable) that cannot be separated into two or more parts, in which case all components are comprised within a single body or housing. Examples of the present invention are applicable to any of these configurations and other configurations of which the skilled person will be aware.

As mentioned, a type of aerosol generating component, such as a heating element, that may be utilized in an atomizing portion of an electronic cigarette (a part configured to generate vapor from a source liquid) combines the functions of heating and liquid delivery, by being both electrically conductive (resistive) and porous. Note here that reference to being electrically conductive (resistive) refers to components which have the capacity to generate heat in response to the flow of electrical current therein. Such flow could be imparted by via so-called resistive heating or induction heating. An example of a suitable material for this is an electrically conductive material such as a metal or metal alloy formed into a sheet-like form, i.e. a planar shape with a thickness many times smaller than its length or breadth. Examples in this regard may be a mesh, web, grill and the like. The mesh may be formed from metal wires or fibers which are woven together, or alternatively aggregated into a non-woven structure. For example, fibers may be aggregated by sintering, in which heat and/or pressure are applied to a collection of metal fibers to compact them into a single porous mass. It is possible for the planar aerosol generating component to define a curved plane and in these instances reference to the planar aerosol generating component forming a plane means an imaginary flat plane forming a plane of best fit through the component.

These structures can give appropriately sized voids and interstices between the metal fibers to provide a capillary force for wicking liquid. Thus, these structures can also be considered to be porous since they provide for the uptake and distribution of liquid. Moreover, due to the presence of voids and interstices between the metal fibers, it is possible for air to permeate through said structures. Also, the metal is electrically conductive and therefore suitable for resistive heating, whereby electrical current flowing through a material with electrical resistance generates heat. Structures of this type are not limited to metals, however. Other conductive materials may be formed into fibers and made into mesh, grill or web structures. Examples include ceramic materials, which may or may not be doped with substances intended to tailor the physical properties of the mesh.

A planar sheet-like porous aerosol generating component of this kind can be arranged within an electronic cigarette such that it lies within the aerosol generating chamber forming part of an airflow channel. The aerosol generating component may be oriented within the chamber such that air flow though the chamber may flow in a surface direction, i.e. substantially parallel to the plane of the generally planar sheet-like aerosol generating component. An example of such a configuration can be found in WO2010/045670 and WO2010/045671, the contents of which are incorporated herein in their entirety by reference. Air can thence flow over the heating element, and gather vapor. Aerosol generation is thereby made very effective. In alternative examples, the aerosol generating component may be oriented within the chamber such that air flow though the chamber may flow in a direction which is substantially transverse to the surface direction, i.e. substantially orthogonally to the plane of the generally planar sheet-like aerosol generating component. An example of such a configuration can be found in WO2018/211252, the contents of which are incorporated herein in its entirety by reference.

The aerosol generating component may have, and/or be formed of, any one of the following structures: a woven or weave structure, mesh structure, fabric structure, open-pored fiber structure, open-pored sintered structure, open-pored foam or open-pored deposition structure. Said structures are suitable in particular for providing an aerosol generating component with a high degree of porosity. A high degree of porosity may ensure that the heat produced by the aerosol generating component is predominately used for evaporating the liquid and high efficiency can be obtained. A porosity of greater than 50% may be envisaged with said structures. In one embodiment, the porosity of the aerosol generating component is 50% or greater, 60% or greater, 70% or greater. The open-pored fiber structure can consist, for example, of a non-woven fabric which can be arbitrarily compacted, and can additionally be sintered in order to improve the cohesion. The open-pored sintered structure can consist, for example, of a granular, fibrous or flocculent sintered composite produced by a film casting process. The open-pored deposition structure can be produced, for example, by a CVD process, PVD process or by flame spraying. Open-pored foams are in principle commercially available and are also obtainable in a thin, fine-pored design.

In one embodiment, the aerosol generating component is formed from a single layer. In one embodiment, the aerosol generating component has at least two layers, wherein the layers contain at least one of the following structures: a plate, foil, paper, mesh, woven structure, fabric, open-pored fiber structure, open-pored sintered structure, open-pored foam or open-pored deposition structure. For example, the aerosol generating component can be formed by an electric heating resistor consisting of a metal foil combined with a structure comprising a capillary structure. Where the aerosol generating component is considered to be formed from a single layer, such a layer may be formed from a metal wire fabric, or from a non-woven metal fiber fabric. Individual layers are advantageously but not necessarily connected to one another by a heat treatment, such as sintering or welding. For example, the aerosol generating component can be designed as a sintered composite consisting of a stainless steel foil and one or more layers of a stainless steel wire fabric (material, for example AISI 304 or AISI 316). Alternatively, the aerosol generating component can be designed as a sintered composite consisting of at least two layers of a stainless steel wire fabric. The layers may be connected to one another by spot welding or resistance welding. Individual layers may also be connected to one another mechanically. For instance, a double-layer wire fabric could be produced just by folding a single layer. Instead of stainless steel, use may also be made, by way of example, of heating conductor alloys-in particular NiCr alloys and CrFeAl alloys (“Kanthal”) which have an even higher specific electric resistance than stainless steel. The material connection between the layers is obtained by the heat treatment, as a result of which the layers maintain contact with one another-even under adverse conditions, for example during heating by the aerosol generating component and resultantly induced thermal expansions. Alternatively, the aerosol generating component may be formed from sintering a plurality of individual fibers together. Thus, the aerosol generating component can be comprised of sintered fibers, such as sintered metal fibers.

The aerosol generating component may comprise, for example, an electrically conductive thin layer of electrically resistive material, such as platinum, nickel, molybdenum, tungsten or tantalum, said thin layer being applied to a surface of the vaporizer by a PVD or CVD process, or any other suitable process. In this case, the aerosol generating component may comprise an electrically insulating material, for example of ceramic. Examples of suitable electrically resistive material include stainless steels, such as AISI 304 or AISI 316, and heating conductor alloys-in particular NiCr alloys and CrFeAl alloys (“Kanthal”), such as DIN material number 2,4658, 2,4867, 2,4869, 2,4872, 1,4843, 1,4860, 1,4725, 1,4765 and 1,4767.

As described above, the aerosol generating component may be formed from a sintered metal fiber material and may be in the form of a sheet. Material of this sort can be thought of a mesh or irregular grid, and is created by sintering together a randomly aligned arrangement or array of spaced apart metal fibers or strands. A single layer of fibers might be used, or several layers, for example up to five layers. As an example, the metal fibers may have a diameter of 8 to 12 μm, arranged to give a sheet of thickness 0.16 mm, and spaced to produce a material density of from 100 g/m² to 1500 g/m², such as from 150 g/m² to 1000 g/m², 200 g/m² to 500 g/m², or 200 to 250 g/m², and a porosity of 84%. The sheet thickness may also range from 0.1 mm to 0.2 mm, such as 0.1 mm to 0.15 mm. Specific thicknesses include 0.10 mm, 0.11 mm, 0.12 mm, 0.13 mm, 0.14 mm, 0.15 mm or 0.1 mm. Generally, the aerosol generating component has a uniform thickness. However, it will be appreciated from the discussion below that the thickness of the aerosol generating component may also vary. This may be due, for example, to some parts of the aerosol generating component having undergone compression. Different fiber diameters and thicknesses may be selected to vary the porosity of the aerosol generating component. For example, the aerosol generating component may have a porosity of 66% or greater, or 70% or greater, or 75% or greater, or 80% or greater or 85% or greater, or 86% or greater.

The aerosol generating component may form a generally flat structure, comprising first and second surfaces. The generally flat structure may take the form of any two dimensional shape, for example, circular, semi-circular, triangular, square, rectangular and/or polygonal. Generally, the aerosol generating component has a uniform thickness.

A width and/or length of the aerosol generating component may be from about 1 mm to about 50 mm. For example, the width and/or length of the vaporizer may be from 1 mm, 2 mm, 3 mm, 4 mm, 5 mm, 6 mm, 7 mm, 8 mm, 9 mm or 10 mm. The width may generally be smaller than the length of the aerosol generating component. It will be understood that the dimensions of the aerosol generating component may be varied.

Where the aerosol generating component is formed from an electrically resistive material, electrical current is permitted to flow through the aerosol generating component so as to generate heat (so called Joule heating). In this regard, the electrical resistance of the aerosol generating component can be selected appropriately. For example, the aerosol generating component may have an electrical resistance of 2 ohms or less, such as 1.8 ohms or less, such as 1.7 ohms or less, such as 1.6 ohms or less, such as 1.5 ohms or less, such as 1.4 ohms or less, such as 1.3 ohms or less, such as 1.2 ohms or less, such as 1.1 ohms or less, such as 1.0 ohm or less, such as 0.9 ohms or less, such as 0.8 ohms or less, such as 0.7 ohms or less, such as 0.6 ohms or less, such as 0.5 ohms or less. The parameters of the aerosol generating component, such as material, thickness, width, length, porosity etc. can be selected so as to provide the desired resistance. In this regard, a relatively lower resistance will facilitate higher power draw from the power source, which can be advantageous in producing a high rate of aerosolization. On the other hand, the resistance should not be so low so as to prejudice the integrity of the aerosol generator. For example, the resistance may not be lower than 0.5 ohms.

Planar aerosol generating components, such as heating elements, suitable for use in systems, devices and articles disclosed herein may be formed by stamping or cutting (such as laser cutting) the required shape from a larger sheet of porous material. This may include stamping out, cutting away or otherwise removing material to create openings in the aerosol generating component. These openings can influence both the ability for air to pass through the aerosol generating component and the propensity for electrical current to flow in certain areas.

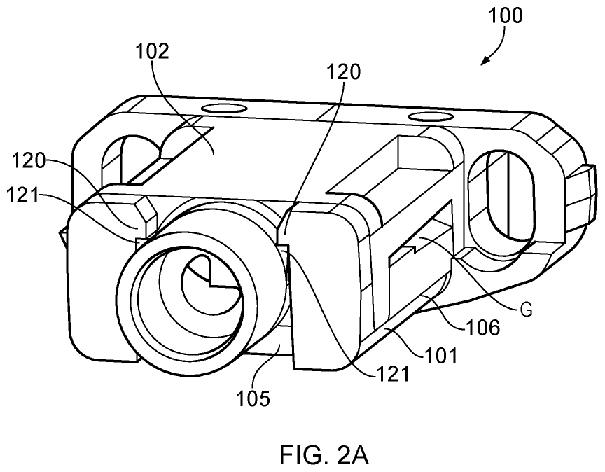

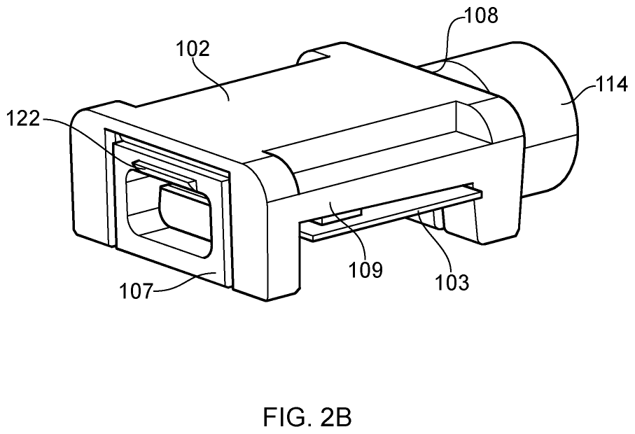

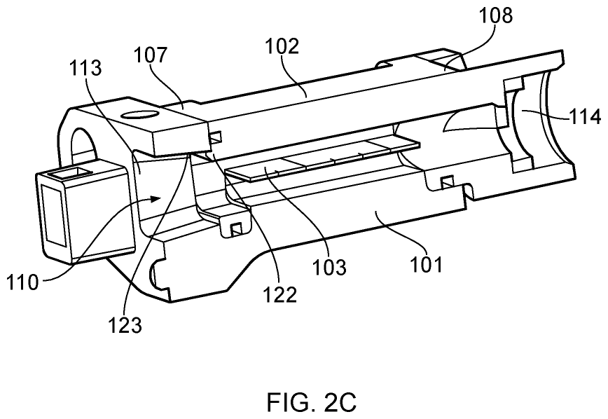

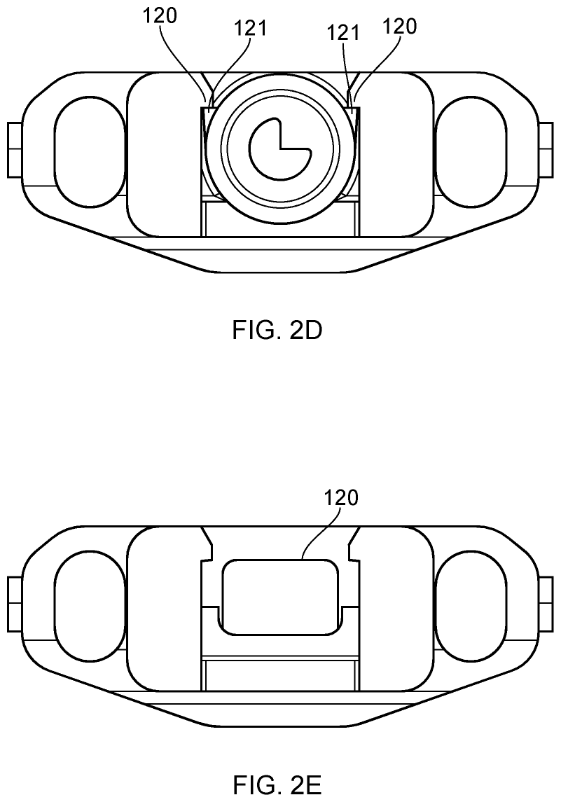

FIG. 2A-C show diagrams (not to scale) of an exemplary article 100 for use in a non-combustible aerosol/vapor provision system 10, according to the present disclosure. In general terms, the article 100 comprises a housing 101, 102, which may comprise a carrier assembly. The carrier assembly may comprise a first carrier component 101 and a second carrier component 102. The article 100 may comprise an aerosol generating component 103 (see FIG. 2B). The aerosol generating component 103 may be at least partially housed within the housing 101, 102 (e.g. within the carrier assembly). The housing (and in the case of this example, the first and second carrier components 101, 102) plays a role in supporting the aerosol generating component 103. Thus, for convenience, and having regard to the orientation represented in the figures, the first and second carrier components 101, 102 also may be considered as a lower cradle component 101 and an upper cradle component 102. The housing may define a gap G (see FIG. 2A) through which aerosolizable material can be fed to the aerosol generating component 103. In this example, the first and second carrier components 101, 102 are separated by a distance d. This separation provides the gap G through which aerosolizable material can be fed to the aerosol generating component 103 in use (e.g. from a reservoir, which is not shown in the Figs.). The gap G provides a capillary channel (one each side) which extends along both sides of the aerosol generating component 103. In some examples, the aerosol generating component 103 is a substantially planar heating element 103.

The article 100 may comprise first and second electrical contact elements for connecting to the aerosol generating component 103 (e.g. corresponding first and second electrical connectors of the aerosol generating component 103). The first and second electrical contact elements may be formed of a sheet metal material, for example comprising metallic strips formed into an appropriate shape having regard to the shape and configuration of the other elements of the apparatus in accordance with conventional manufacturing techniques, or may comprise conventional flexible wiring. In embodiments where electrical energy is inductively coupled to the aerosol generating component it will be understood that such contact elements are not required.

The carrier assembly, e.g. the first and second carrier components 101, 102, may be molded from a plastics material having a high glass fiber content (e.g. at or great than around 50%) to provide improved rigidity and resistance to high temperatures, for example temperatures around 230 degrees centigrade.

The first and second carrier components 101, 102 may be provided in various forms and dimensions. The carrier assembly is constructed so that when the two carrier components 101, 102 are brought together to sandwich the aerosol generating component 103 therebetween, the carrier components 101, 102 form the carrier assembly with an airflow path 110 running down the interior of the carrier assembly and in which the aerosol generating component 103 is at least partially disposed. The airflow path 110 comprises an aerosol generation chamber. The carrier assembly may take on an elongate form, or may have width and length dimensions that are similar. Moreover, the form and dimensions of the airflow path may be varied.

In the example of FIGS. 2A-C, the first carrier component 101 has an upstream portion 104, a downstream portion 105 (shown in FIG. 2A), and two side edges 106 (the right edge being shown in FIG. 2A). As shown in FIGS. 2B and C, the second carrier component 102 has an upstream portion 107, a downstream portion 108, and two side edges 109. The first carrier component 101 and the second carrier component 102 have substantially the same width (measured from side edge to side edge). An air inlet 113 is provided at the upstream portion 104 of the first carrier component 101 (see FIG. 2C), and an air outlet 114 is provided at the downstream portion 108 of the second carrier component 102 (see FIGS. 2B and C). From FIG. 2C in particular, it can be seen that, in use, air flows into the air inlet 113, along the airflow path 110, and through the outlet 114.

The first carrier component 101 and the second carrier component 102 may be attached together by any suitable means, such as by a clearance fit, a transition fit, or an interference fit. Other attachments are envisaged. In some examples, for example the specific example of FIG. 2, the first carrier component 101 and the second carrier component 102 may be attached together by a snap fit. For example, one or more of the first carrier component 101 and the second carrier component 102 may comprise one or more projections configured to engage (e.g. via a snap fit) with a corresponding portion of the other of the first carrier component 101 and the second carrier component 102. In the example of FIGS. 2A-E, the first carrier component 101 comprises a pair of projections 120 provided towards its downstream portion 105, which projections 120 being configured to engage via a snap-fit with a corresponding ledge 121 of the second carrier component 102; and the second carrier component 102 comprises a projection 122 provided at its upstream portion 107, which projection 122 being configured to engage via a snap-fit with a corresponding ledge 123 of the first carrier component 101. It will be understood that the nature of the attachment between the first carrier component 101 and the second carrier component 102 may be varied.

The aerosol generating component 103 may be formed of a porous material. For example, the aerosol generating component 103 may be formed of a conductive material. For example, the aerosol generating component 103 may be formed of a single layer. For example, the aerosol generating component 103 may be formed from a woven or weave structure, mesh structure, fabric structure, open-pored fiber structure, open-pored sintered structure, open-pored foam or open-pored deposition structure. For example, the aerosol generating component 103 may be generally in the form of a sheet. For example, the aerosol generating component 103 may be formed from a sintered metal fiber material and is generally in the form of a sheet. It will be appreciated that other porous conducting materials may equally be used.

For example, the aerosol generating component 103 may comprise a main portion with electrical connectors for connecting to the respective electrical contacts. For example, the main portion of the aerosol generating component may be generally rectangular with a longitudinal dimension (i.e. in a direction running between the electrical contact extensions 103B) of around 20 mm, and a width of around 8 mm. Other dimensions are envisaged.

For example, the longitudinal dimension may correspond to the direction of airflow through the vaporization chamber (note that in other examples, the longitudinal dimension need not be the longest dimension of the aerosol generating component 103). The thickness of the sheet comprising the aerosol generating component 103 may be around 0.15 mm. Other dimensions are envisaged.

The aerosol generating component 103 may comprise one or more apertures 200 (e.g. elongate apertures). In some examples, the aperture(s) 200 may comprise one or more elongate apertures extending inwardly from each of the longer sides (sides parallel to the longitudinal direction). For example, the elongate apertures 200 may extend inwardly by around 4.8 mm. For example, the elongate apertures extending inwardly may be separated from one another by around 5.4 mm on each side of the aerosol generating component 103 with the slots extending inwardly from the opposing sides being offset from one another by around half this spacing. In other words, the slots may be alternately positioned along the longitudinal sides. Other configurations and dimensions are envisaged. A consequence of this arrangement of slots 200 in the aerosol generating component 103 is that current flow along the aerosol generating component 103 is in effect forced to follow a meandering path which results in a concentration of current, and hence electrical power, around the ends of the slots. In this regard, and due to the presence of the elongate apertures, the aerosol generating component 103 can be constructed such that some areas of the aerosol generating component 103 (in this example the meandering path) have a greater propensity for current flow than others.

By having current follow a meandering path, a greater number of high temperature areas (also referred to as “hot spots”) are more evenly distributed across the aerosol generating component 103, relative to having current follow a direct path which provides fewer, larger high temperature areas that are less evenly distributed across the aerosol generating component 103. In this way, the risk of burning of aerosolizable material and/or inadvertent drying out of the aerosol generating component 103 can be reduced. Also, more even heat distribution and thus more consistent aerosolization (e.g. a more consistent particle size) can be achieved.

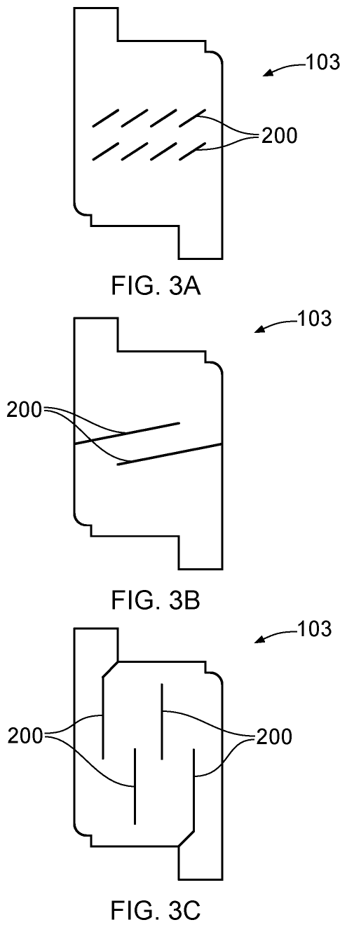

In some examples (see e.g. FIGS. 3A-C), the aerosol generating component 103 is rotationally symmetrical about an axis through the center of, and perpendicular to, the plane of the aerosol generating component 103.

The skilled person will appreciate that the article 100 can be manufactured in various different ways, and that the examples described herein serve as representative examples. For example, the manner in which the aerosol generating component 103 is arranged in the housing, e.g. between the second carrier component 102 and the first carrier component 101, may be varied.

In the example of FIGS. 2A-E, the article 100, once assembled in an aerosol generating system 10 (e.g. an electronic cigarette), comprises a carrier assembly 101, 102 having an airflow path 110 comprising an aerosol generating chamber, wherein the airflow path 110 extends between air inlet(s) and air outlet(s) at a mouthpiece, in the system 10.

It will be appreciated that, in use, the article 100 of FIG. 2 may be surrounded on either side by a reservoir for aerosolizable material (not shown in the Figs.). As discussed, the distance between the first and second carrier components 101, 102 corresponds to a gap G. This gap G is in fluid communication with the reservoir, and provides a capillary channel (one each side) which extends along respective sides of the aerosol generating component 103. For example, in use, aerosolizable material is fed through the gap G and enters the pores (where present) of the aerosol generating component 103 for vaporization to generate a vapor in the aerosol generating chamber. The passing air collects the vapor to generate an aerosol to be drawn out of the aerosol generating chamber and along a further part of the airflow path through the system 10 to exit the air outlet as a user draws on the system 10.

When installed in an electronic cigarette 10, the article 100 may be arranged such that the longitudinal direction of the aerosol generating component 103, corresponding to the direction of airflow through the article 100 from the upstream end to the downstream end, is aligned parallel to the longitudinal axis of the electronic cigarette 10 for an end-to-end system such as the FIG. 1 example, or at least parallel to the longitudinal axis of the device in a side-by-side system having the device arranged to the side of the article 100. This is not compulsory, however, and in the current description, the term “longitudinal” is intended to refer to the dimensions and orientation of the atomizer, in particular the dimension of the aerosol generating component along the airflow path from an atomizer inlet at the upstream end of the atomizer, and through the vaporization chamber to the atomizer outlet at the downstream end of the atomizer.

Exemplary aspects of the present disclosure are described below.

According to an aspect of the present disclosure, there is disclosed an aerosol generating component comprising: at least one elongate slit, wherein the width of one, more, or each elongate slit is up to 0.3 mm. The present inventors have identified that the use of slots (which are wider than slits in the present context), which can be found in aerosol generating components of the prior art, can result in inadvertent leakage of aerosolizable material therethrough. In particular, said slots can act as a leakage path for aerosolizable material. The present inventors have identified that the use of a slit, which has a narrower width than a slot, can reduce the risk of inadvertent leakage of aerosolizable material via the aerosol generating component. At the same time, the use of a slit can provide additional current path, and thus provide for an even heat distribution over the aerosol generating component. In this way, a more consistent particle size, and thus improved aerosolization, can be achieved.

FIGS. 3A-C and 4 illustrate exemplary aerosol generating components 103 comprising at least one elongate slit 200 (not all are numbered for clarity). In this aspect, the width of one, more, or each elongate slit 200 is up to 0.3 mm. As discussed above, this width is effective in reducing the risk of leakage of aerosolizable material, whilst providing effective heating and heat distribution.

The width of one, more, or each elongate slit 200 is greater than 0 mm. In some examples, the width of one, more, or each elongate slit 200 is up to 0.25 mm. In some examples, the width of one, more, or each elongate slit 200 is at least 0.05 mm, or at least 0.1 mm, or at least 0.15 mm. In some examples, the width of one, more, or each elongate slit 200 is between 0.05 mm and about 0.3 mm, or between 0.05 mm and 0.3 mm, or between 0.1 mm and 0.3 mm, or between 0.15 mm and 0.25 mm. In some examples, the width of one, more, or each elongate slit 200 is about 0.2 mm. A width of about 0.2 mm has been found particularly effective at reducing the risk of inadvertent leakage of aerosolizable material.

In some examples, one, more, or each elongate slit 200 is substantially straight. For example, in the examples of FIGS. 3A and 3B, each elongate slit 200 is substantially straight.

In some examples, one, more, or each elongate slit is curved.

In some examples, the aerosol generating component 103 is substantially planar. This configuration is shown in the figures, although it will be appreciated that different geometries are envisaged.

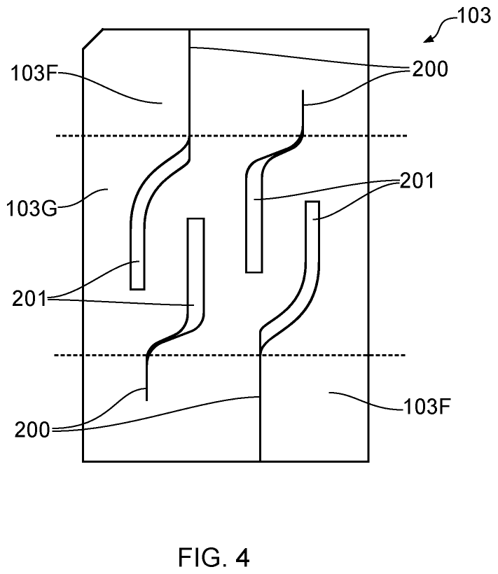

It also will be appreciated that the form of the or each elongate slit 200 can be varied. In some examples, one, more, or each elongate slit 200 comprises multiple elongate slit sections. In some examples, one, more, or each elongate slit section is substantially straight. In some examples, one, more, or each elongate slit section is curved (e.g. in the plane of the substantially planar aerosol generating component 103, such as shown in e.g. FIG. 4).

In some examples, at least two of the elongate slit sections are angled with respect to each other. In some examples, at least two of the elongate slit sections may be non-parallel with respect to each other. In some examples, at least two of the elongate slit sections are obliquely angled with respect to each other. For example, as shown in FIG. 3C, two of the elongate slits 200 each comprise two slit sections, and these are obliquely angled with respect to each other.

In some examples, one, more, or each elongate slit 200 is open at the periphery of the aerosol generating component 103. This configuration is illustrated, for example, in FIGS. 3B, 3C and 4. That is, in each of FIGS. 3B, 3C and 4, two slits 200 are open at the periphery of the aerosol generating component 103. Advantageously, this configuration helps to provide areas of higher current density, whilst being unlikely to present inadvertent leakage of aerosolizable material.

In some examples, one, more, or each elongate slit 200 is enclosed by the periphery of the aerosol generating component. This configuration is illustrated, for example, in FIG. 3A, 3C and 4, wherein a number of the elongate slits 200 are enclosed by the periphery of the aerosol generating component 103. By virtue of the elongate slit 200 being enclosed, the elongate slit 200 is further less likely to form a leakage path for aerosolizable material.

The aerosol generating component 103 may comprise an (e.g. at least one) aerosolizable material feed section 103F configured to receive aerosolizable material (e.g. by capillary force). Aerosolizable material feed sections 103F are illustrated, for example, in FIG. 4, in which the sections outboard of the respective dashed lines correspond to aerosolizable material feed sections 103F.

The aerosol generating component 103G may comprise an (e.g. at least one) aerosolization section 103G configured to aerosolize aerosolizable material. An aerosolization section 103G is illustrated, for example, in FIG. 4, in which the section delineated between the respective dashed lines corresponds to the aerosolization section 103G. It is to be understood that in use, only the aerosolization section 103G may reach a temperature sufficient to aerosolize aerosolizable material.

In some examples, the aerosol generating component 103 has a porous and/or permeable structure into which aerosolizable material can enter. As such, in some examples, the aerosol generating component 103 can take up aerosolizable material, such that it is fed from the aerosolizable material feed section 103F to the aerosolization section 103F to be aerosolized.

In some examples, one, more, or each elongate slit 200 is provided in the aerosolization section 103G.

In some examples, one, more, or each elongate slit 200 is provided in the aerosolization section 103G. In some examples, one, more, or each elongate slit 200 does not extend into the aerosolizable material feed section 103F. By providing the slit(s) in this way, the risk of inadvertent leakage of aerosolizable material is reduced. At the same time, the slit(s) provide additional current path so as to result in additional hot spots. As the total number of hot spots increases and the intensity of each hot spot decreases, heat distribution across the aerosol generating component is improved. This can result in a more consistent particle size, and thus improved aerosolization.

In some examples, one, more, or each elongate slit 200 is connected to an elongate slot 201. In such examples, the elongate slit 200 connected to the elongate slot 201 may form an elongate aperture. In such examples, the slit 200 and the slot 201 may be referred to respectively as “slit portion” 200 and “slot portion” 201.

It is to be appreciated that slits and slots are forms of aperture. It is also to be appreciated that slots are wider than slits.

In some examples, the width of one, more, or each elongate slot 201 is greater than 0.3 mm, or at least 0.35 mm. In some examples, the width of one, more, or each elongate slot 201 is up to 3 mm, or up to 2.5 mm, or up to 2 mm, or up to 1.5 mm, or up to 1 mm, or up to 0.8 mm, or up to 0.7 mm, or up to 0.6 mm, or up to 0.55 mm. In some examples, the width of one, more, or each elongate slot 201 is greater than 0.3 mm and up to 1 mm, or greater than 0.3 mm and up to 0.8 mm, or greater than 0.3 mm and up to 0.6 mm, or greater than 0.3 mm and up to 0.55 mm. In some examples, the width of one, more, or each elongate slot 201 is between 0.25 mm and 1 mm, or between 0.25 mm and 0.8 mm, or between 0.25 mm and 0.6 mm, or between 0.35 mm and 0.55 mm, or between 0.4 mm and 0.5 mm.

In some examples, one, more, or each elongate slit 200 is provided in the aerosolizable material feed section 103F. In some examples, one, more, or each elongate slot 201 is provided in the aerosolization section 103G. Thus, the use of slit(s) 200 in the aerosolizable material feed section 103F reduces the risk of leakage of aerosolizable material (relative to the use of slot(s)). Also, the use of slit(s) 200 in the aerosolizable material feed section 103F can increase the amount of storage for aerosolizable material in the aerosol generating component 103 (relative to the use of slot(s)), since less material is removed from the aerosol generating component 103 (relative to slot(s)). Moreover, the use of slit(s) 200 in the aerosolizable material feed section is such that means for preventing leakage of aerosolizable material via the slit is not necessary. By contrast, in some aerosol generating components wherein a slot extends through the aerosolizable material feed section (and e.g. to the periphery of the aerosol generating component), means for preventing leakage of aerosolizable material via the slot may be necessary.

In some examples, one, more, or each elongate slit 200 extends into the aerosolization section.

In the example of FIG. 4, the elongate slits 200 are connected to respective elongate slots 201 to form respective elongate apertures. The elongate slits 200 are provided (at least partially) in the aerosolizable material feed section 103F, and the elongate slots 201 are provided in the aerosolization section 103G.

It will be understood that in some embodiments, the elongate slot 201 may taper into the slit 200. It will also be understood that different forms of the slit(s) 200 and the slot(s) 201 are envisaged.

The aerosol generating component 103 may comprise one or more electrical connectors 103C. The aerosolization section may be provided between the electrical connectors 103C.

The aerosol generating component may comprise any other features as defined herein.

There is also disclosed an article 100 for use as part of a non-combustible aerosol provision system 10, the article 100 comprising: an aerosol generating component 103 as defined herein; and one or more of an aerosol forming chamber 190 and a reservoir 121 for aerosolizable material.

There is also disclosed a non-combustible aerosol provision system 10 comprising: an article 100 as defined herein; and a device 20 comprising one or more of a power source and a controller.

The system 10 may comprise any other features as defined herein.

According to one aspect, there is disclosed an aerosol generating component comprising at least one curved, elongate aperture. By virtue of its curved shape, the aperture can cover a greater surface area (between a given length) relative to a straight, elongate aperture. In this way, the use of at least one curved, elongate aperture can improve the quantity and/or distribution of aerosol production. For example, aerosol may be produced over an increased surface area.

By “curved”, it is to be understood that the at least one curved, elongate aperture is curved at least in part. That is, the at least one curved, elongate aperture need not necessarily be curved along its entire length, but may include partial curvature (as well as e.g. a straight part). The part of the aperture that is curved may be provided towards the periphery of the aerosol generating component. This may help to reduce the occurrence of “hot spots” in use in locations where these are not desired. The part of the aperture that is curved may be provided in the aerosolizable material feed section.

Referring to FIG. 4, the aerosol generating component 103 comprises at least one curved, elongate aperture 200, 201. In some examples, one, more, or each curved, elongate aperture 200, 201 increases in curvature from one end of the aperture 200, 201 to the other end of the aperture 200, 201. The increase in curvature may be continuous. The increase in curvature may begin part-way along the aperture 200, 201.

In some examples, one, more, or each curved, elongate aperture 200, 201 is curved along at least part of its length.

In some examples, one, more, or each curved, elongate aperture 200, 201 is curved along substantially its entire length.

In some examples, the aerosol generating component 103 is substantially planar.

In some examples, one, more, or each curved, elongate aperture 200, 201 has a substantially constant width.

In some examples, one, more, or each curved, elongate aperture 200, 201 comprises a curved portion (or an at least partially curved portion) connected to a substantially straight portion.

For example, as shown in FIG. 4, there are four apertures 200, 201. Two of the apertures 200, 201 each comprise an at least partially curved portion 201 connected to a substantially straight portion 200. Another two of the apertures 200, 201 each comprise an at least partially curved portion 200 connected to a substantially straight portion 201.

In some examples, one, more, or each curved, elongate aperture 200, 201 comprises a slot portion 201. In some examples, one, more, or each curved, elongate aperture 200, 201 comprises a slit portion 200. In some examples, one, more, or each curved, elongate aperture 200, 201 comprises a slot portion 201 connected to a slit portion 200. It is to be understood that the slot portion 201 has a greater width than the slit portion 200.

It is to be appreciated that slot portions (also referred to as “slots”) are wider than slit portions (also referred to as “slits”).

In some examples, the width of the slot portion is greater than 0.3 mm. In some examples, the width of the slot portion is at least 0.35 mm. In some examples, the width of the slot portion is up to 3 mm, or up to 2.5 mm, or up to 2 mm, or up to 1.5 mm, or up to 1 mm, or up to 0.8 mm, or up to 0.7 mm, or up to 0.6 mm, or up to 0.55 mm. In some examples, the width of the slot portion is greater than 0.3 mm and up to 1 mm, or greater than 0.3 mm and up to 0.8 mm, or greater than 0.3 mm and up to 0.6 mm, or greater than 0.3 mm and up to 0.55 mm. In some examples, the width of the slot portion is between 0.25 mm and 1 mm, or between 0.25 mm and 0.8 mm, or between 0.25 mm and 0.6 mm, or between 0.35 mm and 0.55 mm, or between 0.4 mm and 0.5 mm.

In some examples, the width of the slit portion is up to 0.3 mm. The width of the slit portion is greater than 0 mm. In some examples, the slit portion has a width of up to 0.25 mm. In some examples, the width of the slit portion is at least 0.05 mm, or at least 0.1 mm, or at least 0.15 mm. In some examples, the width of the slit portion is between 0.05 mm and 0.3 mm, or between 0.1 mm and 0.3 mm, or between 0.15 mm and 0.25 mm. In some examples, the width of the slit portion is about 0.2 mm.

It is to be understood that the join/connection between each slot portion 201 and slit portion 200 may be of various widths intermediate of the slot portion 201 and the slit portion 200.

The aerosol generating component 103 may comprise a plurality of curved, elongate apertures. Each curved, elongate aperture may be as defined herein.

In some examples, one, more, or each curved, elongate aperture 200, 201 is open at the periphery of the aerosol generating component 103. As shown in FIG. 4, two of the apertures 200, 201 are open at the periphery of the aerosol generating component 103.

In some examples, one, more, or each curved, elongate aperture 200, 201 is enclosed by the periphery of the aerosol generating component 103. As shown in FIG. 4, two of the apertures 200, 201 are enclosed by the periphery of the aerosol generating component 103.

In some examples, the aerosol generating component 103 comprises an aerosolizable material feed section 103F configured to receive aerosolizable material (e.g. by capillary force).

In some examples, the aerosol generating component 103 comprises an aerosolization section 103G configured to aerosolize aerosolizable material.

In some examples, one, more, or each slot portion 201 is provided in the aerosolization section 103G. In some examples, one, more, or each slot portion 201 does not extend into the aerosolizable material feed section 103F.

In some examples, one, more, or each slit portion 200 is provided in the aerosolizable material feed section 103F. In some examples, one, more, or each slit portion 200 extends into the aerosolization section.

For example, in FIG. 4, each slot portion 201 is provided in the aerosolization section 103G, two slit portions 200 are provided in the aerosolizable material feed section 103F and extend into the aerosolization section 103G, and two slit portions 200 are provided almost entirely in the aerosolizable material feed section 103F. Variations to this configuration are envisaged.

In some examples, the aerosol generating component 103 comprises one or more electrical connectors 103C. The aerosolization section 103G may be provided between electrical connectors 103C.

The aerosol generating component 103 may comprise any other features as defined herein.

There is also disclosed an article 100 for use as part of a non-combustible aerosol provision system 10, the article 100 comprising: an aerosol generating component 103 as defined herein; and one or more of an aerosol forming chamber and a reservoir for aerosolizable material.

The article 100 may be configured such that aerosolizable material can be fed from the reservoir to the aerosolization section 103G via the aerosolizable material feed section 103F.

There is also disclosed a non-combustible aerosol provision system 10 comprising: an article 100 as defined herein; and a device 20 comprising one or more of a power source and a controller.

The system 10 may comprise any other features as defined herein.

According to one aspect, there is disclosed an article for use in a non-combustible aerosol provision system, the article comprising: a housing; and an aerosol generating component having at least one elongate slot, the aerosol generating component being at least partially housed within the housing, the housing defining a capillary gap through which aerosolizable material can be fed to the aerosol generating component, wherein the capillary gap and one, more, or each elongate slot do not overlap.

By providing the elongate slot and the capillary gap so as not to overlap, the potential for leakage of aerosolizable material via the elongate slot is reduced. For example, leakage of aerosolizable material can be more pronounced when the capillary gap coincides with or overlaps the elongate slot.

In some examples, one, more, or each elongate slot 201 is provided inboard of the capillary gap. In this way, the elongate slot 201 is provided away from the capillary gap, towards the center of the aerosol generating element 103. This configuration further reduces the risk of leakage of aerosolizable material.

In some examples, the capillary gap provides a capillary channel which coincides with and/or overlaps a periphery of the aerosol generating component 103. In some examples, the capillary gap provides a capillary channel which coincides with and/or overlaps a side edge of the aerosol generating component 103. In some examples, the capillary gap provides two capillary channels which coincide with and/or overlap a respective side edge of the aerosol generating component 103.

In some examples, one, more, or each elongate slot 201 forms part of an elongate aperture of the aerosol generating component 103 (in which case, the elongate slot may be referred to as an “elongate slot portion”). Thus, the aerosol generating component 103 may comprise at least one elongate aperture having at least one elongate slot 201.

In some examples, the aerosol generating component 103 comprises at least one elongate slit 200. In some examples, one, more, or each elongate slit 200 may form part of an elongate aperture of the aerosol generating component 103 (in which case, the elongate slit may be referred to as an “elongate slit portion”).

In some examples, one, more, or each elongate slot 201 is connected to an elongate slit 200. This may be so as to form an elongate aperture 200, 201. Such a configuration is illustrated in FIG. 4, and is described elsewhere herein.

In some examples, one, more, or each elongate slit 200 and the capillary gap overlap and/or coincide. Providing an elongate slit in this location can provide additional current path, increase resistance and improve heating, whilst maintaining a reduced risk of leakage via the aerosol generating component 103.

The or each elongate slot 200 and the or each elongate slit 200 may be as defined elsewhere herein.

In some examples, the aerosol generating component 103 comprises an aerosolizable material feed section 103F configured to receive aerosolizable material (e.g. by capillary force).

In some examples, the aerosol generating component 103 comprises an aerosolization section 103G configured to aerosolize aerosolizable material. In some examples, the aerosol generating component 103 is substantially planar. The substantially planar aerosol generating component 103 may comprise multiple elongate slots 201 as defined herein.

The aerosolizable material feed section 103F and the aerosolization section 103G may be as described elsewhere herein.

In some examples, one, more or each elongate slot 201 is provided in the aerosolization section 103F.

In some examples, one one, more, or each elongate slit 200 is provided in the aerosolizable material feed section 103G.

In some examples, the aerosolization section 103G and the capillary gap do not overlap.

In some examples, the aerosolizable material feed section 103F and the capillary gap overlap.

It will be appreciated that the housing may be provided in various forms. For example, the housing may comprise a carrier assembly. The housing, e.g. the carrier assembly, may comprise a first carrier component 101 and a second carrier component 102. The first carrier component 101 and the second carried carrier component 102 may define the capillary gap. For example, the capillary gap may be defined by a spacing between the first carrier component 101 and the second carrier component 102, e.g. when the first and second carrier components 101, 102 are attached together. The aerosol generating component 103 may be at least partially arranged between the first carrier component 101 and the second carrier component 102. The first carrier component 101 and the second carrier component 102 may be as described elsewhere herein.

In some examples, the aerosol generating component 103 comprises one or more electrical connectors 103C. The aerosolization section 103G may be provided between electrical connectors 103C.

The article 100 may comprise one or more of an aerosol forming chamber and a reservoir for aerosolizable material.

The article 100 may be configured such that aerosolizable material can be fed from the reservoir to the aerosolization section 103G via the aerosolizable material feed section 103F.

There is also disclosed a non-combustible aerosol provision system 10 comprising: an article 100 as defined herein; and a device 20 comprising one or more of a power source and a controller.

The system 10 may comprise any other features as defined herein.

The Figs. herein are schematic and not drawn to scale. The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. An article for use in a non-combustible aerosol provision system, the article comprising: a housing; and a substantially planar aerosol generating component having at least one elongate slot, the aerosol generating component being at least partially housed within the housing, the housing defining a capillary gap through which aerosolizable material can be fed to the aerosol generating component, wherein the capillary gap and one, more, or each elongate slot do not overlap.

2. An article of claim 1, wherein one, more or each elongate slot is provided inboard of the capillary gap.

3. An article of claim 1, wherein one, more, or each elongate slot is connected to an elongate slit so as to provide at least one elongate aperture.

4. An article of claim 1, wherein one, more, or each elongate slit and the capillary gap overlap.

5. An article of claim 1, wherein the aerosol generating component is substantially planar.

6. An article of claim 1, wherein the aerosol generating component comprises:
an aerosolizable material feed section configured to receive aerosolizable material; and
an aerosolization section configured to aerosolize aerosolizable material.

7. An article of claim 6, wherein one, more, or each elongate slot is provided in the aerosolization section.

8. An article of claim 6, wherein the aerosolization section and the capillary gap do not overlap.

9. An article of claim 6, wherein the aerosolization section is provided inboard of the capillary gap.

10. An article of claim 6, wherein the aerosolizable material feed section and the capillary gap overlap.

11. An article of claim 6, wherein one, more, or each elongate slot is connected to an elongate slit so as to provide at least one elongate aperture, and wherein one, more, or each slit is provided in the aerosolizable material feed section.

12. An article of claim 1, wherein the housing comprises a first carrier component and a second carrier component that are spaced apart so as to define the capillary gap.

13. An article of claim 1, wherein the aerosol generating component comprises one or more electrical connectors.

14. An article of claim 1, comprising and one or more of an aerosol forming chamber and a reservoir for aerosolizable material.

15. An article of claim 1, wherein the aerosol generating component is formed of a porous material.

16. An article of claim 1, wherein the aerosol generating component is formed of an electrically conductive material.

17. An article of claim 1, wherein the aerosol generating component is formed of a single layer.

18. An article of claim 1, wherein the aerosol generating component is formed of a woven or weave structure, mesh structure, fabric structure, open-pored fiber structure, open-pored sintered structure, open-pored foam or open-pored deposition structure.

19. A non-combustible aerosol provision system comprising:
an article of claim 1; and
a device comprising one or more of a power source and a controller.
